(19) United States
(12) Patent Application Publication
(10) Pub. No.: US 2020/0173350 A1
(43) Pub. Date: Jun. 4, 2020

(54) Wastegate Valve Actuator System in an Exhaust System, and Exhaust System

(71) Applicant: MAN Energy Solutions SE, Augsburg (DE)

(72) Inventor: Dirk ZENZ, Augsburg (DE)

(21) Appl. No.: 16/624,026

(22) PCT Filed: Jun. 12, 2018
(86) PCT No.: PCT/EP2018/065473

§ 371 Date: Dec. 18, 2019

(30) Foreign Application Priority Data
Jun. 22, 2017 (DE) 10 2017 113 866.8

(51) Int. Cl. F02B 37/18; F16K 31/04; F16K 41/10

(52) U.S. Cl. CPC F02B 37/186; F16K 41/106; F16K 31/041

(57) ABSTRACT

A wastegate valve actuator system of an exhaust system of an internal combustion engine includes: a wastegate valve having a valve flap pivotable about a pivot axis; an actuator configured to actuate the valve flap of the wastegate valve, the actuator including a drive shaft; and a coupling element configured to convert a movement of the actuator into a movement of the valve flap of the wastegate valve. The drive shaft of the actuator extends coaxially to the pivot axis of the valve flap of the wastegate valve. The coupling element is configured as a rotary axis that runs coaxially to the pivot axis of the valve flap and coaxially to the drive shaft of the actuator. The coupling element connects to a spring bellows element.

### CROSS REFERENCE TO RELATED APPLICATIONS

This is a U.S. national stage of International application No. PCT/EP2018/065473, filed on Jun. 21, 2018, which claims priority to German Application No. 10 2017 113 866.8, filed Jun. 22, 2017, the content of each of which is incorporated herein by reference.

### BACKGROUND OF THE INVENTION

### 1. Field of the Invention

The invention relates to a wastegate valve actuator system of an exhaust system of an internal combustion engine and to an exhaust system.

### 2. Description of the Prior Art

From practice, exhaust systems of internal combustion engines are known that comprise at least one exhaust gas turbocharger. An exhaust gas turbocharger comprises a turbine, via which exhaust gas can be conducted for expansion and extraction of energy, wherein the energy extracted in the turbine of an exhaust gas turbocharger is utilized to drive a compressor of the exhaust gas turbocharger and compress the charge air to be fed to the internal combustion engine. From practice it is already known, furthermore, to assign a wastegate valve to the turbine of an exhaust gas turbocharger of an exhaust system, wherein dependent on the opening position of the wastegate valve, exhaust gas, bypassing the turbine, can be conducted past the exhaust gas turbocharger. Such wastegate valves are also described as bypass valves, which serve in particular for the control or regulation of a charge pressure and for the control and/or regulation of a temperature in the exhaust system.

An actuator adjusts or actuates a wastegate valve. It is known from practice that the actuator is coupled to the wastegate valve via a coupling element to convert the movement of the actuator into a movement of a valve flap of the wastegate valve. It is known from practice to embody the coupling element as a coupling rod, which on one side is connected to a drive shaft of the actuator in an articulated manner and on the other side connected to a pivot axis of the valve flap of the wastegate valve in an articulated manner subject to forming a kinematic lever mechanism.

In an exhaust system of a ship, exhaust gas-conducting assemblies of the exhaust system are typically positioned in a space that is heat-insulated to the outside relative to the surroundings, a so-called hotbox, in order to thereby avoid fuel coming into contact with exhaust gas-conducting assemblies and thus being ignited. Accordingly, the wastegate valve is positioned within such a heat-insulated space, whereas the actuator for actuating the wastegate valve is typically arranged outside this heat-insulated space. The coupling element, for coupling the actuator to the wastegate valve, has to be led into or out of the heat-insulated space. In the case of a coupling element that forms a kinematic lever mechanism, this is problematic. With a coupling element which forms a kinematic lever mechanism there is the risk, furthermore, that the end of the coupling element that is lever-kinematically connected to the pivot axis of the wastegate valve jams as a consequence of temperature-induced deformations. This can cause a wastegate valve failure.

### SUMMARY OF THE INVENTION

Starting out from this, it is an object of the present invention to provide a new type of wastegate valve actuator system of an exhaust system of an internal combustion engine and an exhaust system of internal combustion engine with such a wastegate valve actuator system.

According to an aspect of the invention, the drive shaft of the actuator runs coaxially to the pivot axis of the valve flap of the wastegate valve. The coupling element is configured as a rotary axis that runs coaxially to the pivot axis of the valve flap of the wastegate valve and coaxially to the drive shaft of the actuator, wherein the coupling element is assigned a spring bellows element.

The wastegate valve actuator system according to aspects of the invention avoids the disadvantages known from practice. Because the pivot axis of the valve flap of the wastegate valve, the drive shaft of the actuator and the coupling element configured as a rotary axis all run coaxially relative to one another, the coupling element can convert the movement of the actuator into a movement of the wastegate valve, namely of the valve flap of the same, exclusively by a rotary movement. The spring bellows element assigned to the coupling element can reliably offset thermally induced deformations in the region of the coupling element so that there is no risk the coupling element jamming and the wastegate valve thus failing.

In the case of ship applications, the coupling element, for transferring the coupling element between a heat-insulated space, in which the wastegate valve is positioned, and the actuator, which is arranged outside this heat-insulated space, merely has to be passed through an opening in a wall of the heat-insulated space.

According to an advantageous further development of the invention, the spring bellows element is integrated in the coupling element such that the spring bellows element is coupled between a first end of the rotary axis, with which the same is connected to the drive shaft of the actuator, and a second end of the rotary axis, with which the same is connected to the pivot axis of the valve flap, wherein preferentially a distance of the spring bellows element from the first end of the rotary axis is smaller than from the second end of the rotary axis. Alternatively, the spring bellows element is assigned to the coupling element such that the spring bellows element is coupled between an end of the rotary axis and the drive shaft of the actuator. Accordingly, the spring bellows element in both versions is positioned nearer the actuator than the wastegate valve. In the case of ship applications, the spring bellows element is arranged outside the heat-insulated space. Thus it can be ensured that the spring bellows element is exposed to minor thermal loads.

According to an advantageous further development of the invention, the spring bellows element is a torsion-resistant metal spring bellows element. A torsion-resistant metal spring bellows element is particularly preferred for securely converting the movement of the actuator into a movement of the valve flap of the wastegate valve.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are set forth in the following description. Exemplary embodiments of the invention are explained in more detail by way of the drawings without being restricted to this. In the drawings:

FIG. 1: is a perspective view of a wastegate valve actuator system; and

FIG. 2: is a top view of the wastegate valve actuator system of FIG. 1.

### DETAILED DESCRIPTION OF THE PRESENTLY PREFERRED EMBODIMENTS

The invention relates to a wastegate valve actuator system of an exhaust system of an internal combustion engine and to an exhaust system having such a wastegate actuator system.

The fundamental construction of an exhaust system of an internal combustion engine is familiar to the person skilled in the art addressed here and does not therefore require any closer explanation per se. However for the sake of completeness it is pointed out here that an exhaust system of an internal combustion engine comprises at least one exhaust gas turbocharger with in each case a turbine and a compressor. By way of the turbine of an exhaust gas turbocharger, exhaust gas of the internal combustion engine can be conducted in order to expand the exhaust gas in the turbine and extract energy in the process.

The energy extracted in the turbine of an exhaust gas turbocharger is utilized in the compressor of the respective exhaust gas turbocharger to compress the charge air to be fed to the internal combustion engine. Furthermore, an exhaust system of an internal combustion engine can comprise at least one exhaust gas aftertreatment assembly such as, for example, a catalytic converter and/or a particle filter, which are typically positioned downstream of an exhaust gas turbocharger.

It is already known, furthermore, to assign a wastegate valve to an exhaust gas turbocharger, namely to the turbine of the same, wherein the waste gate valve is also described as a bypass valve. Dependent on the opening position of the wastegate valve, exhaust gas can be conducted past the turbine of an exhaust gas turbocharger, i.e., bypassing the turbine, in particular with the objective of charge pressure regulation and/or exhaust gas temperature regulation downstream of the wastegate valve.

Such a wastegate valve is actuated by an actuator, wherein between the wastegate valve, namely a valve flap to be adjusted of the same, and the actuator, a coupling element is connected in order to convert the movement of the actuator into a movement of the valve flap of the wastegate valve.

The arrangement of wastegate valve, actuator and coupling element is described as wastegate valve actuator system.

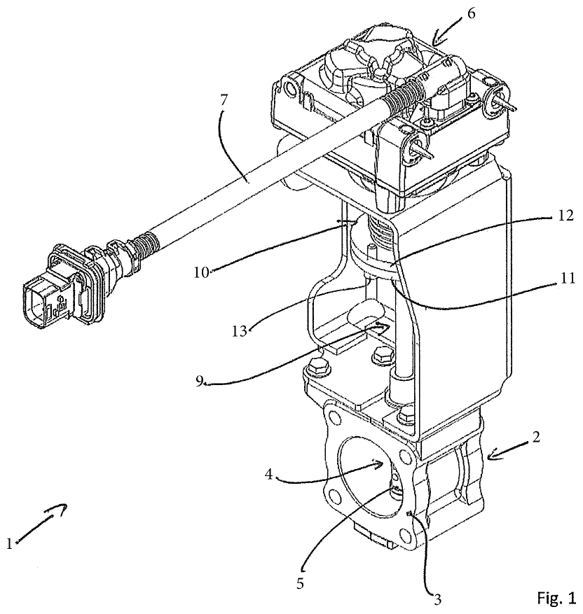

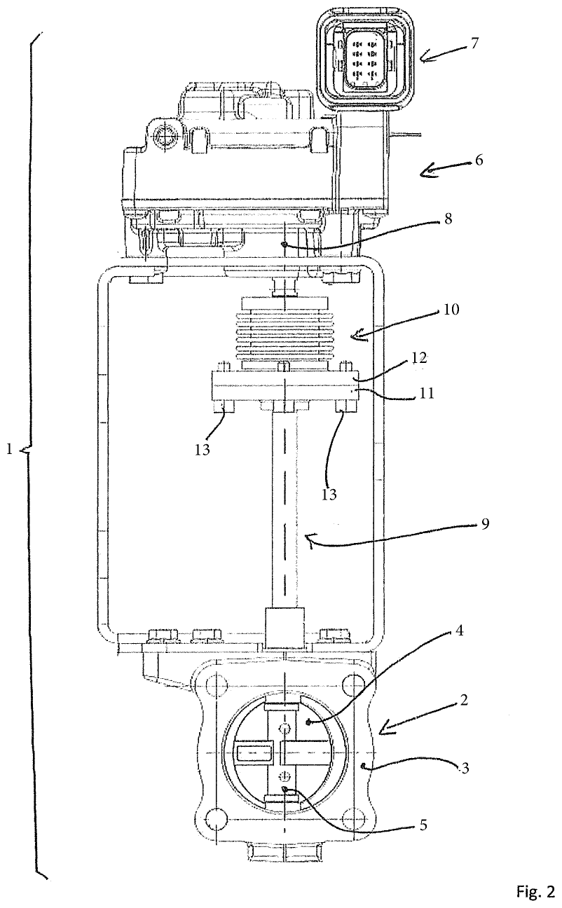

FIGS. 1 and 2 show different views of a wastegate valve system 1 according to an aspect of the invention. This wastegate valve actuator system 1 comprises a wastegate valve 2, wherein the wastegate valve 2 comprises a valve housing 3 and a valve flap 4 received in the valve housing 3. The valve flap 4 of the wastegate valve 2 is pivotable about a pivot axis 5 in order to thereby define or adjust the opening position of closing position of the wastegate valve 2.

The wastegate valve actuator system 1, furthermore, comprises an actuator 6, which is preferentially embodied as electric motor, in particular as a stepping motor. The actuator 6 can be coupled via a cable 7 to a control system (not shown) in order to suitably actuate the actuator 6. Controlled or regulated by the control system, the actuator 6 can be driven as a result of which a movement of a drive shaft 8 of the actuator 6 is brought about.

The actuator 6 configured as a motor is coupled to the valve flap 4 of the wastegate valve 2 via a coupling element 9 to convert the movement of the actuator, namely the rotation of the drive shaft 8 of the actuator 6, into a movement, namely a rotation or pivot movement of the valve flap 4 of the wastegate valve 2.

In the case of the wastegate valve actuator system 1 according to the aspect, the drive shaft 8 of the actuator 6 runs coaxially to the pivot axis 5 of the valve flap 4 of the wastegate valve 2. The coupling element 9 is configured as a rotary axis, which runs coaxially to the pivot axis 5 of the valve flap 4 and coaxially to the drive shaft 8 of the actuator 6. Accordingly, for converting the movement of the rotary axis 8 of the actuator 6 into a pivot movement of the valve flap 4 of the wastegate valve 2, the coupling element 9 designed as rotary axis merely has to perform a rotary movement. A kinematic lever mechanism for coupling the actuator 6 to the wastegate valve 2 can be omitted. This is advantageous, in particular when, as is customary on ships, the wastegate valve 2 is positioned within a heat-insulated space and the actuator 6 outside the heat-insulated space and the coupling element 9 has to be passed through an opening in a wall of the heat-insulated space. In this case, the coupling element 9 configured as a rotary axis can then be simply passed through a suitable recess in the wall of the heat-insulated space and sealed relative to this recess.

In the case of the wastegate valve actuator system 1 according to the invention, the coupling element 9 configured as a rotary axis is associated with a spring bellows element 10. Preferentially, this spring bellows element 10 is a torsion-resistant metal spring bellows element. By way of such spring element 10 the rotary movement of the drive shaft 8 of the actuator 6 can, on the one hand be securely converted into a pivot movement of the valve flap 4 of the wastegate valve 2, while on the other hand can easily and reliably offset or compensate for thermally induced deformations in the region of the coupling element 9.

The spring bellows element 10 is preferentially arranged in relation to the coupling element 9 such that the spring bellows element 10 is connected between the coupling element 9 and the drive shaft 8 of the actuator 6, namely such that the spring bellows element 10 on one side is connected to the drive shaft 8 of the actuator 6 and on the other side is connected to a first end of the coupling element 9, wherein a second end of the coupling element 9 is connected to the pivot axis 5 of the valve flap 4 of the wastegate valve 2. The connection of the spring bellows element 10 to the first end of the coupling element 9 is effected, in the illustrated exemplary embodiment, via a flange connection, namely via a connection of a flange 11, which is formed on the first end of the coupling element 9, and a flange 12, which is formed on the adjoining section of the spring bellows element 10, wherein these two flanges 11, 12 according to FIGS. 1 and 2 are connected to one another via screws 13. Such a flange connection is optional. Connecting the spring element 10 to the coupling element 9 can also be effected in a different way, for example by welding.

It is also possible to integrate the spring element 10 in the coupling element 9, namely such that the spring bellows element 10 is coupled between a first end of the coupling element 9, with which the same is connected to the drive shaft 8 of the actuator 6, and a second end of the rotary axis 9, with which the same is connected to the pivot axis 5 of the valve flap 4 of the wastegate valve 2.

In this case, a distance of the spring bellows element 10 from the first end of the rotary axis is preferentially smaller than from the second end of the rotary axis. With this configuration and the configuration shown in FIGS. 1 and 2 it is ensured that the spring bellows element 10 is positioned nearer the actuator 6 than the wastegate valve 2 so that in the case in which ship applications the wastegate valve 2 is arranged within the heat-insulated space and the actuator 6 outside the same, the spring bellows element 10 is also positioned outside the heat-insulated space and accordingly exposed to minor thermal loads.

Although not preferred it is also possible to assign the spring bellows element 10 to the rotary axis or the coupling element 9 such that the spring bellows element 10 is coupled between an end of the rotary axis and the pivot axis 5 of the valve flap 4 of the wastegate valve 2.

According to an aspect of the invention, a wastegate valve actuator system 1 is accordingly proposed that comprises a wastegate valve 2 with a valve flap 4 that can be pivoted about a pivot axis 5, an actuator 6 preferentially configured as stepping motor with a drive shaft 8 and a coupling element 9 configured as a rotary axis for converting the movement of the actuator 6 into a pivot movement of the valve flap 4 of the wastegate valve 2, wherein the pivot axis 5 of the wastegate valve 2, the drive shaft 8 of the actuator 6 and the coupling element 9 all run coaxially relative to one another, and wherein the coupling element 9 is associated with a spring bellows element 10, preferentially a torsion-resistant metal spring bellows element 10, via which on one side the rotary movement of the actuator 6 can be securely converted into a pivot movement of the valve flap, and via which temperature-induced deformations can be compensated for in the region of the coupling element 9. The wastegate valve actuator system 1 is simple and failsafe.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### LIST OF REFERENCE NUMBERS

1 Wastegate valve actuator system

2 Wastegate valve

3 Valve housing

4 Valve flap

5 Pivot axis

6 Actuator

7 Cable

8 Drive shaft

9 Coupling element

10 Spring bellows element

11 Flange

12 Flange

13 Screw

1-9. (canceled)

10. A wastegate valve actuator system (1) of an exhaust system of an internal combustion engine, comprising:
a wastegate valve (2) having a valve flap (4) pivotable about a pivot axis (5);
an actuator (6) configured to actuate the valve flap (4) of the wastegate valve (2), the actuator (6) comprising a drive shaft (8); and
a coupling element (9) configured to convert a movement of the actuator (6) into a movement of the valve flap (4) of the wastegate valve (2),
wherein
the drive shaft (8) of the actuator (6) extends coaxially to the pivot axis (5) of the valve flap (4) of the wastegate valve (2), and
the coupling element (9) is configured as a rotary axis that runs coaxially to the pivot axis (5) of the valve flap (4) and coaxially to the drive shaft (8) of the actuator (6), wherein the coupling element (9) connects to a spring bellows element (10).

11. The wastegate valve actuator system according to claim 10, wherein the spring bellows element (10) is connected to the coupling element (9) and arranged such that the spring bellows element (10) is coupled between an end of the rotary axis and the drive shaft (8) of the actuator (6).

12. The wastegate valve actuator system according to claim 10, wherein the spring bellows element (10) is integrated in the coupling element (9) such that the spring bellows element (10) is coupled between a first end of the rotary axis, with which the first end of the rotary axis is connected to the drive shaft (8) of the actuator (6), and a second end of the rotary axis, with which the second end of the rotary axis is connected to the pivot axis (5) of the valve flap (4).

13. The wastegate valve actuator system according to claim 11, wherein a distance of the spring bellows element (10) from the first end of the rotary axis is smaller than the distance of the spring bellows element (10) from the second end of the rotary axis.

14. The wastegate valve actuator system according to claim 10, wherein the spring bellows element (10) is arranged with respect to the coupling element (9) such that the spring bellows element (10) is coupled between an end of the rotary axis and the pivot axis (5) of the valve flap (4).

15. The wastegate valve actuator system according to claim 10, wherein the spring bellows element (10) is a torsion-resistant metal spring bellows.

16. The wastegate valve actuator system according to claim 10, wherein the actuator (6) is an electric motor.

17. The wastegate valve actuator system according to claim 16, wherein the electric motor is a stepping motor.

18. An exhaust system of an internal combustion engine, comprising:
an exhaust gas turbocharger comprising a turbine and a compressor, and
the wastegate valve actuator system (1) according to claim 10.
